(19) United States
(12) Patent Application Publication
(10) Pub. No.: US 2014/0055495 A1
(43) Pub. Date: Feb. 27, 2014

(54) RESPONSIVE USER INTERFACE ENGINE FOR DISPLAY DEVICES

(71) Applicants: Chang Gyum KIM, Chuncheon (KR); Jae Hyun LIM, JeonBuk (KR); Ah Young HWANG, Seoul (KR)

(72) Inventors: Chang Gyum KIM, Chuncheon (KR); Jae Hyun LIM, JeonBuk (KR); Ah Young HWANG, Seoul (KR)

(73) Assignee: LG CNS CO., LTD., Seoul (KR)

(21) Appl. No.: 13/591,379

(22) Filed: Aug. 22, 2012

(51) Int. Cl. G09G 5/32

(52) U.S. Cl. CPC G09G 5/32
USPC 345/660

(57) ABSTRACT

Embodiments of the present invention provide a responsive user interface engine for displaying data in a single format on a variety of display device types. Specifically, a responsive user interface engine receives data from a single source intended for display on a plurality of display devices. A common layout for the data is loaded for the display devices. For each display device, the layout is scaled based on the display device type. A first rendering of the data using the scaled layout is performed for each display device. The layout is modified for each display device based on the respective screen size of the display device for optimization. For each display device, the data is rendered a second time based on the modified layout. The respective second rendering may be displayed on each display device as a common user interface.

### TECHNICAL FIELD

In general, embodiments of the present invention provide an approach for displaying data on display devices. Specifically, embodiments of the present invention relate to a responsive user interface engine for displaying data in a single format on a variety of display device types.

### BACKGROUND

The growth of electronic display devices such as mobile phones, computers, and personal digital assistants (PDAs) has exploded in recent years. Electronic display devices are well known and used for a wide variety of applications for which information, and user interaction with information, are critical. Given the plethora of information presented to users of electronic display devices, it is important that the displays be efficiently used so as to present as much useful information as possible while maintaining clarity and ease of use when interacting with the presented information.

In today's world, it is increasing likely that one person may own several of the various electronic display devices. Having a variety of different display devices, however, can make it difficult for a user to navigate, find, and browse the different types of data content because most of the different display devices on the market today have a unique interface. A single user of multiple display devices, therefore, must learn a new interface for each new display device to consume the same content on the different display devices. For some users, it can be difficult to switch between the many different devices and the different user interfaces.

In addition, the frequent development of new programming efforts for different devices increases the development costs and maintenance. When a new device is introduced, the lack of responsiveness of the new device continues to occur in a mobile environment. One current technology is to use the cascading style sheet (CSS) media queries which can control various display devices, but a complex system in an enterprise environment may not work smoothly. Typically, the screen layout and user interface design theme are selected by the developer of the different devices and, therefore, quality control becomes an issue. Heretofore, several unsuccessful attempts have been made to address these shortcomings.

U.S. Patent Application 20100020102 discloses a method for browsing information on a hand-held device having a display by adjusting the view on the display device in a manner as natural as possible so that the user of the hand-held device can concentrate on the information displayed on the display device and not on the adjustment of the displayed information.

U.S. Patent Application 20100060549 discloses methods and systems that dynamically generate different user environments from a handheld device for secondary devices with displays of various form factors.

U.S. Pat. No. 6,976,226 discloses a method and system that translates tabular data prepared for one display format into a second display format.

U.S. Pat. No. 6,948,002 discloses a method and system of interfacing a computer system executing commercial transactions initiated from communication devices, each communication device having a display with custom display parameters.

U.S. Pat. No. 6,636,243 discloses a system and method for displaying a status of critical indicators on diverse display devices and indicating a history of change statuses.

U.S. Pat. No. 6,181,300 discloses a display data format conversion circuit and method that facilitates display of data on a plurality of display devices based on display data of a source display device.

None of these references, however, teach a single user interface engine that varies the display and size when rendering data from a single source on multiple display devices.

### SUMMARY

In general, embodiments of the present invention provide a responsive user interface engine for displaying data in a single format on a variety of display device types. Specifically, a responsive user interface engine receives data from a single source intended for display on a plurality of display devices. A common layout for the data is loaded for the display devices. For each display device, the layout is scaled based on the display device type. A first rendering of the data using the scaled layout is performed for each display device. The layout is modified for each display device based on the respective screen size of the display device for optimization. For each display device, the data is rendered a second time based on the modified layout. The respective second rendering may be displayed on each display device as a common user interface.

A first aspect of the present invention provides a responsive user interface engine for generating a common user interface, comprising: a memory; a data module configured to receive data intended for display on a first screen of a first display device and a second screen on a second display device and load the data into a memory; a layout module configured to load a common layout structure into the memory; a screen size module configured to determine a first screen size associated with the first screen and a second screen size associated with the second screen; a scaler module configured to perform a first scaling of the common layout structure based on the first screen size and a second scaling of the common layout structure based on the second screen size; a renderer module configured to perform a first rendering of the data based on the first scaling and a second rendering of the data based on the second scaling; a modifier module configured to perform a first modification of the first rendering based on the first screen size and a second modification of the second rendering based on the second screen size; and the renderer module further configured to perform a third rendering of the data based on the first modification and a fourth rendering of the data based on the second modification, wherein the third rendering and the fourth rendering represent a responsive user interface.

A second aspect of the present invention provides a method for deploying a responsive user interface engine for generating a common user interface, comprising: providing a computer infrastructure being operable to: receive data intended for display on a first screen of a first display device and a second screen on a second display device and load the data into a memory; load a common layout structure into the memory; determine a first screen size associated with the first screen and a second screen size associated with the second screen; perform a first scaling of the common layout structure based on the first screen size and a second scaling of the common layout structure based on the second screen size; perform a first rendering of the data based on the first scaling and a second rendering of the data based on the second scaling; perform a first modification of the first rendering based on the first screen size and a second modification of the second rendering based on the second screen size; and perform a third rendering of the data based on the first modification and a fourth rendering of the data based on the second modification, wherein the third rendering and the fourth rendering represent a responsive user interface.

A third aspect of the present invention provides a computer-implemented method for displaying a common user interface, comprising: receiving data; loading a format for the data; determining a first screen size of a first display device and a second screen size of a second display device; generating a first scaled layout by scaling the format based on the first screen size and a second scaled layout by scaling the format based on the second screen size; generating a first rendering based on the first scaled layout and a second rendering based on the second scaled layout; optimizing the first rendering and the second rendering; generating a third rendering based on the optimizing of the first rendering and a fourth rendering based on the optimizing of the second rendering; and displaying the third rendering to the first screen and the fourth rendering on the second screen, wherein the third rendering and the fourth rendering comprise a common user interface.

A fourth aspect of the present invention provides a computer program product for generating a responsive user interface for a display device among a plurality of display devices, the computer program product comprising a computer readable storage medium, and program instructions stored on the computer readable storage medium, to: receive data intended for a screen of a display device; load a common layout structure; determine a size of the screen; scale the common layout structure based on the size of the screen; perform a first rendering of the data using the scaled common layout structure; modify the scaled common layout structure based on the size of the screen; and perform a second rendering of the data using the modified common layout structure, wherein the second rendering represents a common user interface.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an example data from a single source displayed on different display device types according to an embodiment of the present invention.

FIG. 2 shows example display layouts which can be implemented on different display device types according to an embodiment of the present invention.

FIGS. 3A-C show example display formats based on the type of data being presented according to an embodiment of the present invention.

FIG. 4 shows an example responsive user interface engine in an example environment according to an embodiment of the present invention.

FIG. 5 shows an example method flow diagram for providing a responsive user interface engine according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Embodiments of the present invention provide a responsive user interface engine for displaying data in a single format on a variety of display device types. Specifically, a responsive user interface engine receives data from a single source intended for display on a plurality of display devices. A common layout for the data is loaded for the display devices. For each display device, the layout is scaled based on the display device type. A first rendering of the data using the scaled layout is performed for each display device. The layout is modified for each display device based on the respective screen size of the display device for optimization. For each display device, the data is rendered a second time based on the modified layout. The respective second rendering may be displayed on each display device as a common user interface.

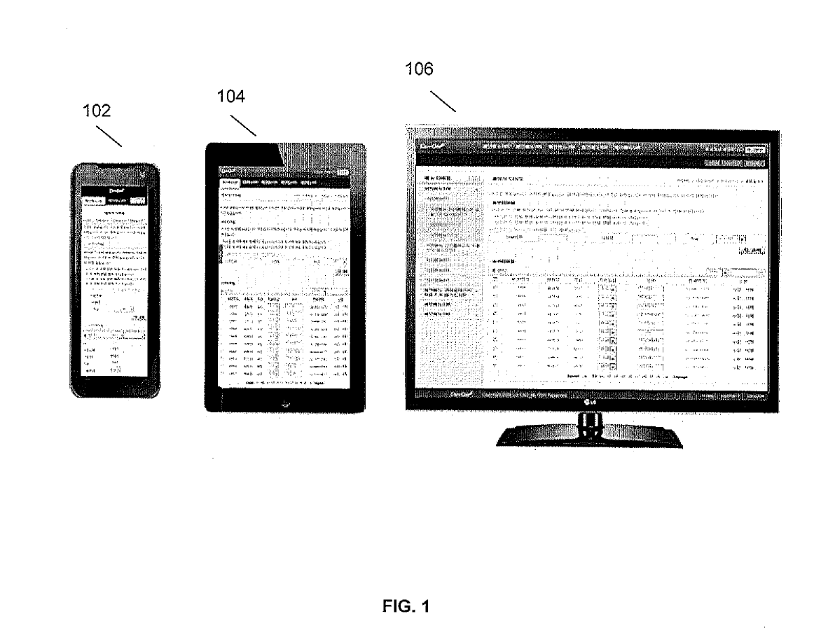

FIG. 1 shows an example data from a single source displayed on different display device types according to an embodiment of the present invention. As depicted, the display device types include a smartphone 102, tablet 104, and desktop 106. A display device type may include a desktop, laptop, notebook, tablet, personal data assistant (PDA), cell phone, smartphone, or any electronic device having a display screen. The display screen may be a liquid crystal display (LCD), light-emitting diode (LED), plasma, projection, cathode ray tube (CRT), or any other appropriate illumination screen.

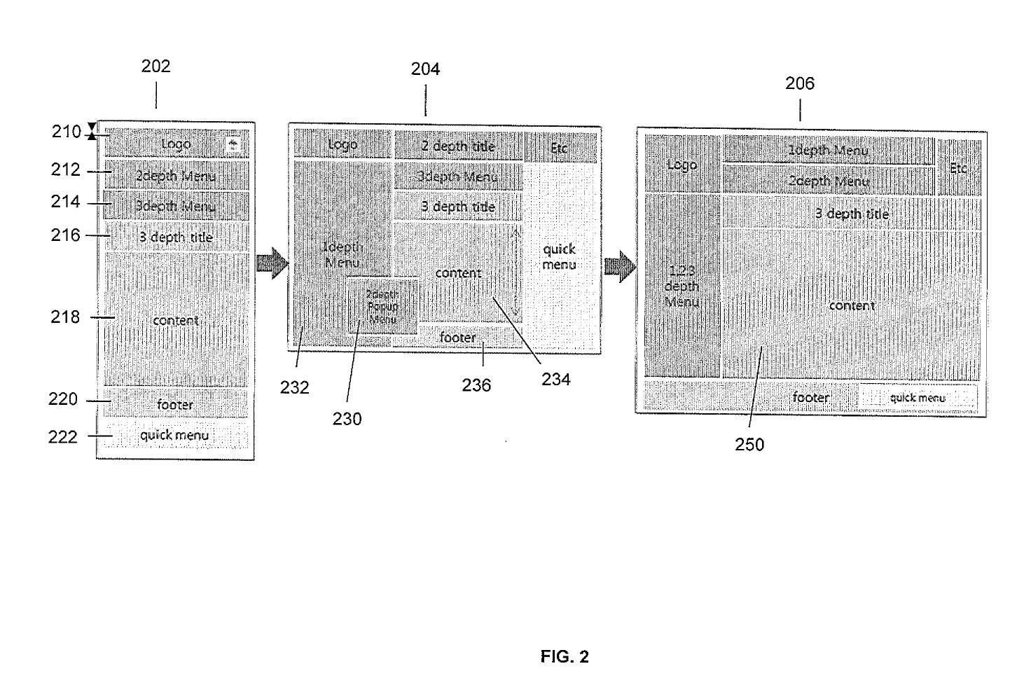

FIG. 2 shows example display layouts which can be implemented on different display device types according to an embodiment of the present invention. Each layout illustrates various regions for displaying data to a user. For example, smartphone layout 202 includes logo 210, 2 depth menu 212, 3 depth menu 214, 3 depth title 216, content 218, footer 220, and quick menu 222.

The layout of each display device for displaying data may differ depending on the device. For example, smartphone layout 202 may comprise only a single column due to the slim width of the smartphone. However, tablet layout 204 may be able to include multiple columns because it may have a greater width than a smartphone. However, tablet layout 204 may have some constraints when attempting to display a large amount of data. To that end, tablet layout 204 may overlap certain regions, such as 2 depth popup menu 230 may overlap with 1 depth popup menu 232, content 234, and footer 236. Certain regions, such as content 234 may vary in size depending on the content being displayed in that region and other surrounding regions. Having the largest display screen of the three example display devices, desktop layout 206 may include multiple rows and columns of data, require no overlapping of different regions, and provide ample space for each respective region, such as content 250.

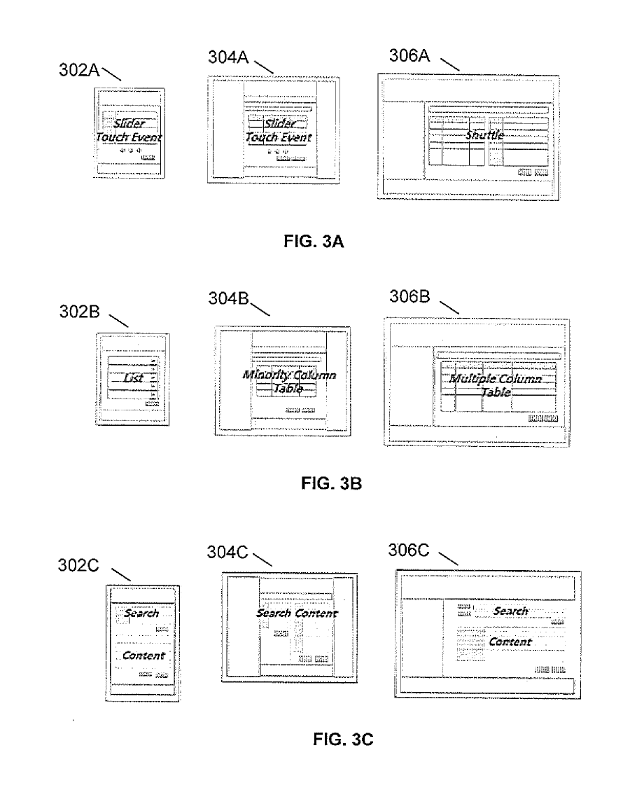

FIGS. 3A-C show example display formats based on the type of data being presented according to an embodiment of the present invention. As depicted, FIGS. 3A-C each illustrate data being displayed on a smartphone 302A-C, tablet 304A-C, and desktop 306A-C. FIG. 3A illustrates a ‘tap format’. For example, the tap format may be employed for touch events, such as a slider touch event. Use of a slider touch event as the example touch event is for illustrative purposes only and not intended to be limiting. Other touch events may use the tap format. A touch event is any event requiring the use of a touch sensor, such as a touch sensing button, slider, shuttle, touch panel, or the like.

Smartphone 302A illustrates a format requiring a slider touch event typical on many smartphones having a slider touch screen. A common user interface on today's smartphone includes a touch screen, which is an electronic visual display that can detect the presence and location of a touch within a display area. One example slider touch event is “unlocking” the phone for use. The smartphone may also have a default lock screen. The lock screen is brought up on the touch screen of the smart phone when the user wakes up the phone by, for example, depressing a wakeup button on the phone. The lock screen may provide an option to “unlock” the phone via a slider. Once the user slides the slider to unlock the phone, the other functions of the phone become available to the user. Due to the limited display area of a typical smart phone, the slider may consume much of the display screen.

Tablet 304A illustrates an example tablet tap format requiring a touch screen event. Similar to the smart phone example above, many tablets also are capable of handling one or more slider touch events, such as unlocking the tablet. However, the size of the tablet generally allows for the presentation of more data to a user to the increased display area compared to a typical smart phone.

Desktop 306A illustrates an example desktop tap format having a responsive shuttle. The desktop 306A may allow for use of a shuttle rather than the slider used in smart phone 302A and tablet 304A due to the increase display area of the desktop 306A. The display screen of a desktop typically has a greater display area than either a smart phone or tablet allowing for data to be presented in a different way and in a different size. The use of a larger display device may also allow for the display of more data on a single screen. The presentation of the same data may need more than one screen when being presented to a user on a smaller display device.

FIG. 3B illustrates a ‘table format’ for presenting data on various display devices. The data being presented on each of the display devices originates from a single data table. Smartphone 302B illustrates the table data displayed in a “list” view. In other words, due to the limited display area on the smartphone 302B, the table data is presented in a single column. Tablet 304B illustrates a minority column table. In the other words, the table data is displayed with a minimum number of columns. Alternatively, desktop 306B displays a multiple column table. In other words, the table data from the single source is presented to the users in multiple columns.

FIG. 3C illustrates a ‘view area format’ for presenting data on various display devices. The data being presented on each of the display devices includes a search region and a content region. Smartphone 302C illustrates the search region displayed above the content region, with minimal display area accommodating each region. Tablet 304C illustrates the search region and the content region displayed side-by-side on the screen. Desktop 306C displays the search and content regions. The size of each displayed region is greater compared to the respective region sizes on the smartphone 302C and tablet 304C.

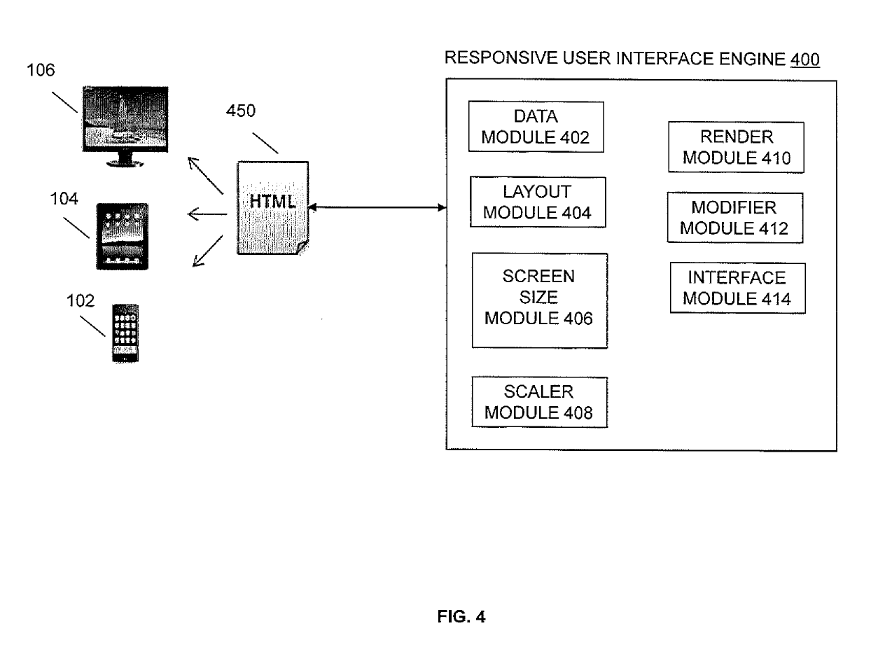

FIG. 4 shows an example responsive user interface engine in an example environment according to an embodiment of the present invention. To begin the process, data (e.g., HTML 450) is received and loaded to the responsive user interface engine 400 by data module 420. The data may be used to generate web content to be displayed on various display devices with a common user interface. The data may comprise a markup language, such as hypertext markup language (HTML), or any other appropriate data which can be used to generate a web page. The display devices of the example shown in FIG. 4 include a smartphone 102, a tablet 104, and a PC 106. In one example, a user may provide a common layout structure (e.g. one or more cascading style sheets) which may be used to define the presentation semantics (i.e., the look and formatting) of the web page to be displayed on the various devices. The common layout structure provided by the user may be stored in a layout repository (not shown). In a second example, the data may specify by name a layout (e.g., by providing the name of one or more cascading style sheets) to be used. The common layout structure, having previously been stored in the layout repository (perhaps in a file or table format), may be retrieved and loaded from the layout repository. The common layout structure may be loaded by layout module 404.

The screen size of each display device may be determined by screen size module 406. For example, a screen size of 700px (or pixel width of 700 pixels) may be defined as a smartphone. A screen size of more than 700px, but less than 1280px, may be defined as a tablet. A screen size of more than 1280px may be defined as a PC. In one example, screen size module 406 accomplishes this task using media queries. Without media queries, fluid layouts would struggle to adapt to the array of screen sizes on the hundreds of devices out there. Fluid layouts can appear cramped and unreadable on small mobile devices and too large and chunky on big widescreen displays. Media queries make it possible to adapt typography to the size and resolution of the user's device, making it a tool for crafting a more pleasurable device experience.

Scaler module 408 produces a scaled layout for each device based on determinations made by the media queries. Renderer module 410 may produce a first rendering of the data for each device using the respective scaled layout for each device. Modifier module 412 may make modifications to one or more of the first renderings to optimize the respective user interface. For example, a 2-dimensional table may be displayed on PC 106, but the table may need to be displayed in a list form on the smartphone 102. In one example, to perform each optimization, a predefined JavaScript module may be executed. The screen size of the respective display device may determine which JavaScript module to execute. For example, a JavaScript module for a PC may be loaded when the device type is determined to be a PC. A JavaScript module for a tablet may be loaded when the device type is determined to be a tablet. A JavaScript module for a smartphone may be loaded when the device type is determined to be a smartphone.

Renderer module 410 may generate a second rendering for each display device after any modifications to the respective layouts has been made. Interface module 414 may provide each respective display device the appropriate data to generate a common user interface on each device.

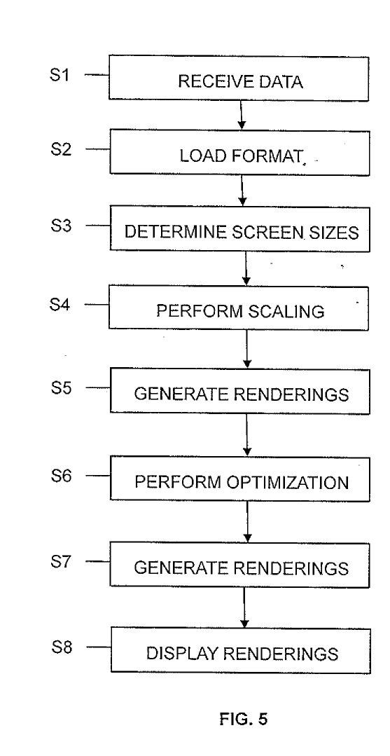

FIG. 5 shows a method flow diagram for providing a common user interface engine according to an embodiment of the present invention. At S1, data is received. At S2, a format for the data is loaded. At S3, the screen sizes of the various display devices are determined. At S4, a scaling is performed of each format based on the respective screen size. At S5, first renderings are generated for each display device. At S6, optimization is performed for each display device. At S7, second renderings are generated for each display device. At S8, the renderings are display on the respective display devices.

It should be noted that, in some alternative implementations, the functions noted in the blocks may occur out of the order noted in FIG. 5. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Further, it can be appreciated that the methodologies disclosed herein can be used within a computer system to provide a common user interface service, as shown in FIG. 1. In this case, responsive user interface engine 400 can be provided, and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary responsive user interface engine 400 may be described in the general context of computer-executable instructions, such as program modules, being executed by a computer. Generally, program modules include routines, programs, people, components, logic, data structures, and so on, that perform particular tasks or implement particular abstract data types. Exemplary responsive user interface engine 400 may be practiced in distributed computing environments where tasks are performed by remote processing devices that are linked through a communications network. In a distributed computing environment, program modules may be located in both local and remote computer storage medium including memory storage devices.

Furthermore, an implementation of exemplary responsive user interface engine 400 may be stored on or transmitted across some form of computer readable media. Computer readable media can be any available media that can be accessed by a computer. By way of example, and not limitation, computer readable media may comprise “computer storage medium” and “communications media.”

“Computer storage medium” include volatile and non-volatile, removable and non-removable media implemented in any method or technology for storage of information such as computer readable instructions, data structures, program modules, or other data. Computer storage medium includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention a responsive user interface engine for displaying data in a single format on a variety of display device types. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A responsive user interface engine for generating a common user interface, comprising:
a memory;
a data module configured to receive data intended for display on a first screen of a first display device and a second screen on a second display device and load the data into a memory;
a layout module configured to load a common layout structure into the memory;
a screen size module configured to determine a first screen size associated with the first screen and a second screen size associated with the second screen;
a scaler module configured to perform a first scaling of the common layout structure based on the first screen size and a second scaling of the common layout structure based on the second screen size;
a renderer module configured to perform a first rendering of the data based on the first scaling and a second rendering of the data based on the second scaling;
a modifier module configured to perform a first modification of the first rendering based on the first screen size and a second modification of the second rendering based on the second screen size; and
the renderer module further configured to perform a third rendering of the data based on the first modification and a fourth rendering of the data based on the second modification, wherein the third rendering and the fourth rendering represent a responsive user interface.

2. The responsive user interface engine of claim 1, further comprising an interface module configured to provide the third rendering on the first screen and the fourth rendering for display on the second screen.

3. The responsive user interface engine of claim 1, wherein the data is formatted as hypertext markup language (HTML).

4. The responsive user interface engine of claim 1, wherein the size of the screen is determined using at least one media query.

5. The responsive user interface engine of claim 1, wherein the first screen size and the second screen size are different.

6. The responsive user interface engine of claim 1, wherein the common layout structure comprises at least one cascading style sheet (CSS).

7. The responsive user interface engine of claim 1, wherein the common layout structure is retrieved from a repository.

8. The responsive user interface engine of claim 1, wherein the modifier module comprises a JavaScript module.

9. A method for deploying a responsive user interface engine for generating a common user interface, comprising:
providing a computer infrastructure being operable to:
receive data intended for display on a first screen of a first display device and a second screen on a second display device and load the data into a memory;
load a common layout structure into the memory;
determine a first screen size associated with the first screen and a second screen size associated with the second screen;
perform a first scaling of the common layout structure based on the first screen size and a second scaling of the common layout structure based on the second screen size;
perform a first rendering of the data based on the first scaling and a second rendering of the data based on the second scaling;
perform a first modification of the first rendering based on the first screen size and a second modification of the second rendering based on the second screen size; and
perform a third rendering of the data based on the first modification and a fourth rendering of the data based on the second modification, wherein the third rendering and the fourth rendering represent a responsive user interface.

10. The method of claim 9, the computer infrastructure being operable to provide the third rendering on the first screen and the fourth rendering for display on the second screen.

11. The method of claim 9, wherein the data is formatted as hypertext markup language (HTML).

12. The method of claim 9, wherein the size of the screen is determined using at least one media query.

13. The method of claim 9, wherein the first screen size and the second screen size are different.

14. The method of claim 9, wherein the common layout structure comprises at least one cascading style sheet (CSS).

15. The method of claim 9, wherein the common layout structure is retrieved from a repository.

16. The method of claim 9, wherein the modifier module comprises a JavaScript module.

17. A computer-implemented method for displaying a common user interface, comprising:
receiving data;
loading a format for the data;
determining a first screen size of a first display device and a second screen size of a second display device;
generating a first scaled layout by scaling the format based on the first screen size and a second scaled layout by scaling the format based on the second screen size;
generating a first rendering based on the first scaled layout and a second rendering based on the second scaled layout;
optimizing the first rendering and the second rendering;
generating a third rendering based on the optimizing of the first rendering and a fourth rendering based on the optimizing of the second rendering; and
displaying the third rendering to the first screen and the fourth rendering on the second screen, wherein the third rendering and the fourth rendering comprise a common user interface.

18. The computer-implemented method of claim 17, providing the third rendering on the first screen and the fourth rendering for display on the second screen.

19. A computer program product for generating a responsive user interface for a display device among a plurality of display devices, the computer program product comprising a computer readable storage medium, and program instructions stored on the computer readable storage medium, to:
receive data intended for a screen of a display device;
load a common layout structure;
determine a size of the screen;
scale the common layout structure based on the size of the screen;
perform a first rendering of the data using the scaled common layout structure;
modify the scaled common layout structure based on the size of the screen; and
perform a second rendering of the data using the modified common layout structure, wherein the second rendering represents a common user interface.

20. The computer program product of claim 19, the computer readable storage medium further comprising instructions to provide the third rendering on the first screen and the fourth rendering for display on the second screen.
